(19) United States
(12) Patent Application Publication
(10) Pub. No.: US 2025/0360499 A1
(43) Pub. Date: Nov. 27, 2025

(54) A DIESEL OXIDATION CATALYST AND A METHOD FOR ITS MANUFACTURE

(71) Applicant: JOHNSON MATTHEY PUBLIC LIMITED COMPANY, London (GB)

(72) Inventors: Andrew CHIFFEY, Hertfordshire (GB); Kieran COLE, Hertfordshire (GB); Lee GILBERT, Hertfordshire (GB); Robert HANLEY, Hertfordshire (GB); Gudmund SMEDLER, Gothenburg (SE)

(21) Appl. No.: 18/872,379

(22) PCT Filed: Jul. 12, 2023
(86) PCT No.: PCT/GB2023/051829

§ 371 Date: Dec. 6, 2024

(30) Foreign Application Priority Data
Aug. 4, 2022 (GB) 2211400.3

(51) Int. Cl. B01J 37/02; B01D 53/94; B01J 21/04; B01J 23/58; B01J 35/00; B01J 35/30; B01J 35/45; B01J 35/57; B01J 37/08; B01J 37/10; F01N 3/035; F01N 3/10; F01N 3/20; F01N 3/28

(52) U.S. Cl. CPC B01J 37/0244; B01D 53/944; B01D 53/9477; B01J 21/04; B01J 23/58; B01J 35/19; B01J 35/393; B01J 35/45; B01J 35/57; B01J 37/0242; B01J 37/088; B01J 37/10; F01N 3/035; F01N 3/106; F01N 3/2066; F01N 3/28; B01D 2255/1021; B01D 2255/1023; B01D 2255/9032; B01D 2255/9155; B01D 2255/9202; B01D 2257/404; B01D 2257/502; B01D 2257/702; B01D 2258/012; F01N 2370/02; F01N 2510/0684

(57) ABSTRACT

A method for the manufacture of a diesel oxidation catalyst comprises: (i) providing a carrier substrate; (ii) forming one or more platinum-group-metal-containing washcoat layers each comprising a refractory metal oxide support material on the carrier substrate to provide a first coated substrate; (iii) subjecting the first coated substrate to a first heat treatment to form a heat-treated coated substrate, wherein the first heat treatment comprises heating the first coated substrate to a first maximum temperature and holding the first coated substrate at the first maximum temperature; (iv) depositing a platinum-group-metal-containing composition comprising a refractory metal oxide support material on at least a portion of the heat-treated coated substrate to form a second coated substrate; and (v) subjecting the second coated substrate to a second heat treatment to form the diesel oxidation catalyst, wherein the second heat treatment comprises heating the second coated substrate to a second maximum temperature and holding the second coated substrate at the second maximum temperature; wherein the first maximum temperature is at least 600° C. and wherein the second maximum temperature is at least 25° C. lower than the first maximum temperature.

The present invention relates to an improved diesel oxidation catalyst (DOC) and, in particular, to a method for the manufacture of the DOC. The method of manufacture provides a DOC with stabilised NO to NO₂ oxidation performance, without compromising the CO/HC oxidation performance and/or exotherm generation capability.

Internal combustion engines produce exhaust gases containing a variety of pollutants, including hydrocarbons (HCs), carbon monoxide (CO), and nitrogen oxides (“NOx”). Emission control systems, including exhaust gas catalytic conversion catalysts, are widely utilized to reduce the amount of these pollutants emitted to atmosphere. For compression-ignition (i.e., diesel) engines, the most commonly used catalytic converter is the diesel oxidation catalyst (DOC). DOCs typically contain palladium and/or platinum, generally supported on alumina. This catalyst converts particulate matter (PM), hydrocarbons, and carbon monoxide to carbon dioxide and water.

In modern exhaust systems, the DOC is used during normal operation to control these CO and HC emissions. The DOCs role in the passive oxidation of HC, CO and NOx present in the exhaust gas flow occurs throughout the operation of the engine and is optimised for the operating window of the DOC between about 250 and 300° C. The DOC can also be used to promote the conversion of NO to NO₂ for downstream passive filter regeneration (the combustion of particulate matter held on a filter in NO₂ at lower exhaust gas temperatures than in O₂ in the exhaust gas, i.e. the so-called CRT® effect).

In addition, the DOC may be used as an exotherm generation catalyst. This is performed via injection of hydrocarbon fuel into exhaust gas. For the avoidance of doubt, the fuel injection/exotherm generation event does not take place during normal operation: normal operation is considered to be the period between fuel injection/exotherm generation events. The second role for exotherm generation can serve one of several purposes. For example, the exotherm can be generated to combust soot on downstream filters when an unacceptable increase in back pressure is detected. Another example is for the regeneration of SCR catalysts, such as by removing sulphur from downstream CuCHA SCR catalysts.

In order to generate these exotherms an amount of hydrocarbon (HC) is injected upstream of the DOC (˜2000 ppm). Provided that the DOC is hot enough, the added HC will lead to the production of an exotherm, heating the exhaust gases and, consequently, heating those downstream components (up to temperatures of around 500° C.). If the DOC is not hot enough then it is necessary through engine management to provide a hotter exhaust from the engine with an associated energy and performance impact.

Accordingly, it is desirable to provide a DOC with a low exotherm generation temperature. The lower this temperature the more likely the engine is to already be working above the exotherm temperature when an exotherm is required and/or the smaller the amount of energy that needs to be added to reach a suitable operating temperature.

It is known that the performance characteristics of a catalyst article may change during the lifetime of a catalyst article. Some of this performance may be regained with a regeneration process, but some of the performance is simply lost such as by sintering of platinum group metal (PGM) components. This can provide difficulties when trying to provide a well calibrated exhaust system, able to operate optimally across the length of its service life. In some instances, the performance delta can provide such difficulties that it is actually desirable to pre-age the component before use, to reach a point in its lifetime performance where the ongoing delta in performance observed by the end-user is minimised. That is, exhaust system manufacturers may prefer to sacrifice some fresh activity to ensure a more consistent performance across the lifetime of the part.

U.S. Pat. No. 8,679,434B1 discloses a method for the preparation of thermally stabilised powders. In particular, this disclosure provides a honeycomb substrate having disposed thereon a washcoat containing one or more calcined platinum group metal components dispersed on a refractory metal oxide support located on the honeycomb substrate, the platinum group metal components having an average crystallite size in the range of about 10 to about 25 nm to provide a stable ratio of NO₂ to NOx when the exhaust gas flows through the honeycomb substrate. These powders which have been aged to reduce their activity, and to thereby minimise the change of performance during aging in use, can then be washcoated onto a substrate to form a catalyst article. In use the performance of the catalyst article is then more stable.

US20160236178A1 discloses the preparation of chemically reduced PGM materials that can be thermally treated to give a preferred PGM size for NO oxidation. In particular, this disclosure provides a method of preparing a catalyst composition for producing a stable ratio of NO₂ to NO in an exhaust system of a compression ignition engine is described. The method comprises: (i) preparing a first composition comprising a platinum (Pt) compound disposed or supported on a support material; (ii) preparing a second composition by reducing the platinum (Pt) compound to platinum (Pt) with a reducing agent; and (iii) heating the second composition to at least 650° C.

It is an object of the invention to provide an improved method for the manufacture of a DOC, to tackle problems associated with the prior art and/or to at least provide a commercially viable alternative thereto.

According to a first aspect the present invention provides a method for the manufacture of a diesel oxidation catalyst, the method comprising:
(i) providing a carrier substrate;
(ii) forming one or more platinum-group-metal-containing washcoat layers each comprising a refractory metal oxide support material on the carrier substrate to provide a first coated substrate;
(iii) subjecting the first coated substrate to a first heat treatment to form a heat-treated coated substrate, wherein the first heat treatment comprises heating the first coated substrate to a first maximum temperature and holding the first coated substrate at the first maximum temperature;
(iv) depositing a platinum-group-metal-containing composition comprising a refractory metal oxide support material on at least a portion of the heat-treated coated substrate to form a second coated substrate; and
(v) subjecting the second coated substrate to a second heat treatment to form the diesel oxidation catalyst, wherein the second heat treatment comprises heating the second coated substrate to a second maximum temperature and holding the second coated substrate at the second maximum temperature;
wherein the first maximum temperature is at least 600° C. and wherein the second maximum temperature is at least 25° C. lower than the first maximum temperature.

The present disclosure will now be described further. In the following passages, different aspects/embodiments of the disclosure are defined in more detail. Each aspect/embodiment so defined may be combined with any other aspect/embodiment or aspects/embodiments unless clearly indicated to the contrary. In particular, any feature indicated as being preferred or advantageous may be combined with any other feature or features indicated as being preferred or advantageous.

In the context of a DOC, it is known from aging trials that a thermal treatment of a finished catalyst can be used to moderate fresh catalytic activity. This has the effect of thereby reducing the delta between fresh and aged performance. This is particularly advantageous for systems, such as those containing SCRF components, where low temperature activity can be sensitive to NO/NO₂ ratios. Performing thermal treatment on a finished catalyst will, however, also moderate the CO and HC treatment, and exotherm activity of the catalyst, which is undesirable.

The inventors have now found that by carrying out a thermal treatment at an intermediate stage it is possible to selectively stabilise the NO oxidation activity, then apply a further coating which provides the vast majority of the fresh CO/HC and exotherm properties. This additional coating is desirably applied to the inlet, since this is the portion most required for the CO/HC and exotherm properties. NO oxidation typically occurs over at least the rear section of the catalyst, so this section should be applied before the stabilising thermal treatment is performed. Thermal treatments at temperatures greater than 600° C. are required to stabilise the NO activity.

In more detail, the present invention relates to a method for the manufacture of a diesel oxidation catalyst (DOC). The catalyst is generally in the form of a DOC article. By a catalyst article it is meant a single component for an exhaust gas treatment system. These are also sometimes referred to as “bricks”.

The method comprises providing a carrier substrate. This is the surface onto which catalyst layers are subsequently applied and on which they are supported.

Preferably the substrate is a flow-through monolith. The flow-through monolith substrate has a first face and a second face defining a longitudinal direction there between. The flow-through monolith substrate has a plurality of channels extending between the first face and the second face. The plurality of channels extends in the longitudinal direction and provide a plurality of inner surfaces (e.g. the surfaces of the walls defining each channel). Each of the plurality of channels has an opening at the first face and an opening at the second face. The first face is typically at an inlet end of the substrate and the second face is at an outlet end of the substrate. For the avoidance of doubt, a flow-through monolith substrate is not a wall flow filter.

The channels may be of a constant width and each plurality of channels may have a uniform channel width. Preferably within a plane orthogonal to the longitudinal direction, the monolith substrate has from 300 to 900 channels per square inch, preferably from 400 to 800. The channels can have cross sections that are rectangular, square, circular, oval, triangular, hexagonal, or other polygonal shapes.

The monolith substrate acts as a support for holding catalytic material. Suitable materials for forming the monolith substrate include ceramic-like materials such as cordierite, silicon carbide, silicon nitride, zirconia, mullite, spodumene, alumina-silica magnesia or zirconium silicate, or of porous, refractory metal. Such materials and their use in the manufacture of porous monolith substrates are well known in the art.

It should be noted that the substrate described herein is a single component (i.e. a single brick), nonetheless, when forming an emission treatment system, the substrate used may be formed by adhering together a plurality of channels or by adhering together a plurality of smaller substrates as described herein. Such techniques are well known in the art, as well as suitable casings and configurations of the emission treatment system.

In embodiments wherein the catalyst article of the present invention comprises a ceramic substrate, the ceramic substrate may be made of any suitable refractory material, e.g., alumina, silica, ceria, zirconia, magnesia, zeolites, silicon nitride, silicon carbide, zirconium silicates, magnesium silicates, aluminosilicates and metallo aluminosilicates (such as cordierite and spodumene), or a mixture or mixed oxide of any two or more thereof. Cordierite, a magnesium aluminosilicate, and silicon carbide are particularly preferred.

In embodiments wherein the catalyst article of the present invention comprises a metallic substrate, the metallic substrate may be made of any suitable metal, and in particular heat-resistant metals and metal alloys such as titanium and stainless steel as well as ferritic alloys containing iron, nickel, chromium, and/or aluminium in addition to other trace metals.

The method comprises forming one or more platinum-group-metal-containing washcoat layers on the carrier substrate to provide a first coated substrate. Platinum-group-metals or PGMs as discussed herein are selected from the list comprising or consisting of ruthenium, rhodium, palladium, osmium, iridium, and platinum. However, in practice these preferably comprise or consist of platinum and palladium.

Preferably the one or more platinum-group-metal-containing washcoat layers on the carrier substrate further comprises an alkaline earth metal, preferably strontium and/or barium. These materials are particularly useful for enhancing the exotherm generation properties of the DOC.

The formation of a washcoat layer comprising a PGM is well known in the art. This generally involves preparing a washcoat slurry. This involves mixing together a number of ingredients. The term “slurry” as used herein may encompass a liquid comprising insoluble material, e.g. insoluble particles. The slurry may comprise (1) solvent; (2) soluble content, e.g. free PGM ions (i.e. outside of the support); and (3) insoluble content, e.g. support particles. A slurry is particularly effective at disposing a material onto a substrate, in particular for maximized gas diffusion and minimized pressure drop during catalytic conversion. The slurry is typically stirred, more typically for at least 10 minutes, more typically for at least 30 minutes, even more typically for at least an hour. The stirring of the slurry may occur prior to disposing the slurry on the substrate, for example.

A first preferable ingredient in a washcoat slurry is a support material. Support materials are generally refractory metal oxide powders. It is preferred that the refractory metal oxide support material is selected from the group consisting of alumina, silica, zirconia, ceria and a composite oxide or a mixed oxide of two or more thereof, most preferably selected from the group consisting of alumina, silica and zirconia and a composite oxide or a mixed oxide of two or more thereof. Mixed oxides or composite oxides include silica-alumina and ceria-zirconia, most preferably silica-alumina. Preferably, the refractory metal oxide support material does not comprise ceria or a mixed oxide or composite oxide including ceria. More preferably, the refractory oxide is selected from the group consisting of alumina, silica and silica-alumina. The refractory oxide may be alumina. The refractory oxide may be silica. The refractory oxide may be silica-alumina.

The inclusion of a dopant may stabilise the refractory metal oxide support material or promote catalytic reaction of the supported platinum group metal. Typically, the dopant may be selected from the group consisting of zirconium (Zr), titanium (Ti), silicon (Si), yttrium (Y), lanthanum (La), praseodymium (Pr), samarium (Sm), neodymium (Nd), barium (Ba) and an oxide thereof. In general, the dopant is different to the refractory metal oxide (i.e. the cation of the refractory metal oxide). Thus, for example, when the refractory metal oxide is titania, then the dopant is not titanium or an oxide thereof.

When the refractory metal oxide support material is doped with a dopant, then typically the refractory metal oxide support material comprises a total amount of dopant of 0.1 to 10% by weight. It is preferred that the total amount of dopant is 0.25 to 7% by weight, more preferably 2.5 to 6.0% by weight. Preferably the dopant is silica, because oxidation catalysts comprising such support materials in combination with platinum group metals and alkaline earth metals promote oxidation reactions, such as CO and hydrocarbon oxidation.

Preferably the support material is selected from optionally doped alumina, silica, titania and combinations thereof.

A further ingredient in the washcoat is the PGM component, preferably a salt of the PGM components. Thus, the washcoat typically contains a palladium (Pd) salt and/or a platinum (Pt) salt. Preferably these salts are readily soluble in water. Preferably the Pd and Pt salts are independently selected from nitrates, chlorides and bromide. Preferably the washcoat slurry is Rh-free. Preferably the platinum-group metals present in the washcoat slurry consist of Pt and Pd.

Optional further ingredients which are conventional in forming washcoat slurries may also be present. These include one or more of a binder and a thickening agent. Binders may include, for example, an oxide material with small particle size to bind the individual insoluble particles together in washcoat slurry. The use of binders in washcoats is well known in the art. Thickening agents may include, for example, a natural polymer with functional hydroxyl groups that interacts with insoluble particles in washcoat slurry. It serves the purpose of thickening washcoat slurry for the improvement of coating profile during washcoat coating onto substrate. It is usually burned off during washcoat calcination. Examples of specific thickening agents/rheology modifiers for washcoats include glactomanna gum, guar gum, xanthan gum, curdlan schizophyllan, scleroglucan, diutan gum, Whelan gum, hydroxymethyl cellulose, carboxymethyl cellulose, hydroxyethyl cellulose, methyl cellulose, methyl hydroxyethyl cellulose, methyl hydroxypropyl cellulose and ethyl hydroxycellulose.

The slurry preferably has a solids content of from 10 to 40%, preferably from 15 to 35%. Such a solids content may enable slurry rheologies suitable for disposing the loaded support material onto the substrate. For example, if the substrate is a honeycomb monolith, such solid contents may enable the deposition of a thin layer of washcoat onto the inner walls of the substrate.

Forming a washcoat layer to obtain a coated substrate involves a step of applying the washcoat slurry to at least a portion of the substrate to form a washcoated substrate. Disposing the slurry on a substrate may be carried out using techniques known in the art. Typically, the slurry may be poured into the inlet of the substrate using a specific moulding tool in a predetermined amount, thereby disposing the loaded support material on the substrate. As discussed in more detail below, subsequent vacuum and/or air knife and/or and drying steps may be employed during the disposition step. When the support is a filter block, the loaded support material may be disposed on the filter walls, within the filter walls (if porous) or both.

The pH of the slurry may be adjusted using nitric acid or citric acid and optionally a base such as ammonia or barium hydroxide, before coating, in order to obtain the desired pH. Use of a base may be useful for ensuring that the pH is not adjusted to a pH that is too low.

The method then comprises subjecting the first coated substrate to a first heat treatment to form a heat-treated coated substrate. The first heat treatment comprises heating the first coated substrate to a first maximum temperature and holding the first coated substrate at the first maximum temperature. As will be appreciated, a typical heat treatment process involves passing a substrate through a furnace with zones of increasing temperature. It is the maximum temperature reached that has the primary effect on the substrate being heated. Therefore, the key parameters of a heat treatment process are the maximum temperature reached and time spent at that temperature.

The first maximum temperature is at least 600° C. Preferably the first maximum temperature is from 625 to 750° C., preferably from 650 to 700° C. Preferably the first coated substrate is held at the first maximum temperature for at least 30 minutes, preferably for from 1 hour to 3 hours. Shorter times may not be sufficient to achieve the desired aging and longer times are less commercially desirable. Unduly long times may lead to an undesirably high level of aging and a total loss of desired performance. The first heat treatment may be conducted under moisture containing conditions, although ambient moisture is sufficient, preferably the aging is performed under conditions of 5 to 15 wt % H₂O.

The first heat treatment may be performed in two steps. The first step would be a conventional calcining step and then a second aging step can be performed. Preferably, however, the aging step is sufficient to carry out simultaneous calcining and aging.

While calcination steps can be performed at a range of temperatures when forming catalyst articles, the optimum temperature is determined by the nature of the washcoat and the application of the final catalyst. In general it is desirable to use the lowest temperature that still causes suitable calcination, since this incurs the lowest process cost and has the lowest likelihood of damaging the article. In general, DOC calcination temperatures are in the region of about 500° C. (such as 450-550° C.) since this is sufficient to calcine the part without undue damage or loss of function. Accordingly, the present first heat treatment is performed at a temperature which is higher than a normal calcination step. Furthermore, the object of the first heat treatment is to effect aging of the part, such that the combination of the maximum temperature reached and time spent at that temperature are greater than a normal calcination step.

The one or more platinum-group-metal-containing washcoat layers formed on the substrate preferably provide a PGM loading on the coated substrate after the first heat treatment of from 10 to 50 g/ft³, more preferably 20 to 40 g/ft³.

The one or more platinum-group-metal-containing washcoat layers preferably together cover substantially the entire length of the substrate. That is, preferably the coated substrate has a continuous platinum-group-metal-containing coating extending from an inlet end to the outlet end of the carrier substrate. Alternatively, the one or more platinum-group-metal-containing washcoat layers may together cover at least 40%, more preferably at least 60% and most preferably at least 80% of an axial length of the substrate. This coverage preferably extents from the outlet end.

When the coated substrate has a continuous platinum-group-metal-containing coating extending from an inlet end to the outlet end of the carrier substrate, preferably the continuous platinum-group-metal-containing coating is zoned, wherein an inlet zone comprises Pt and Pd, and whereby an outlet zone comprises Pt and, optionally Pd. Preferably the continuous platinum-group-metal-containing coating consists of the inlet and outlet zones.

After the first heat treatment, the method further comprises depositing a platinum-group-metal-containing composition on at least a portion of the heat-treated coated substrate to form a second coated substrate. That is, a fresh layer or zone of a platinum-group-metal-containing composition is formed on the aged coated substrate. This provides fresh PGM material for CO and HC oxidation, as well as potentially exotherm generation properties.

The fresh layer or zone may be applied by a range of techniques including washcoating, as discussed above. Alternatively, the fresh layer or zone may be achieved by impregnating the aged coated substrate (or a portion thereof) directly with a salt of the PGM.

Preferably the fresh layer or zone is provided only on an upstream portion of the substrate extending from an inlet end of the substrate. Preferably the washcoat is provided over less than 40% of an axial length of the substrate and preferably from 10 to 30% of the axial length, extending from an inlet end of the substrate. In general the fresh layer or zone will sit entirely on the original one or more platinum-group-metal-containing washcoat layers. However, in embodiments where the one or more platinum-group-metal-containing washcoat layers do not extend the full length, there may be no or only partial overlap between the fresh layer or zone and the aged coating on the substrate.

After depositing a platinum-group-metal-containing composition on at least a portion of the heat-treated coated substrate to form a second coated substrate, the second coated substrate to a second heat treatment to form the diesel oxidation catalyst, wherein the second heat treatment comprises heating the second coated substrate to a second maximum temperature and holding the second coated substrate at the second maximum temperature. It is required that the second maximum temperature is at least 25° C. lower than the first maximum temperature. Preferably the second maximum temperature is at least 50° C. lower than the first maximum temperature, more preferably from 100 to 250C lower.

Desirably, the second heat treatment step is a conventional calcination step. Preferably the second heat treatment is performed with the second maximum temperature of from 400 to 575° C., preferably from 450 to 550° C. Preferably the second heat treatment is performed with the second coated substrate held at the second maximum temperature for at least 30 minutes, preferably for from 1 hour to 3 hours.

As will be appreciated, in a conventional process with multiple layers applied with intervening calcination steps, each calcination step would be performed under the same conditions. There is no reason to switch the heat treatment temperatures and certainly no reason to have a higher temperature first heat treatment than a second.

The first and second heat treatments are typically carried out in an oven or furnace, more typically a belt or static oven or furnace, typically in hot air at a specific flow from one direction. Either step may also comprise an initial drying step. The drying and heat treatment steps may be continuous or sequential. For example, a separate washcoat may be applied after the substrate is already washcoated and dried with a previous washcoat. A washcoated substrate can also be dried and heat treated using one continuous heating program if coating is completed. During the heating, any complex that may have formed in the solution may at least partially, substantially or completely decompose. In other words, the ligands of such a complex, e.g. an organic compound, may be at least partially, substantially or completely removed or separated from the PGM ions, and may be removed from the final catalyst article. Particles of such separated palladium may then begin to form metal-metal and metal-oxide bonds. As a result of the heating (calcination), the substrate is typically substantially free of the organic compound, more typically completely free of the organic compound.

Following each heating step, the substrate is typically cooled, more typically to room temperature. The cooling is typically carried out in air with or without cooling agent/media, typically without cooling agent.

It has been found that efficient exotherm generation can be best achieved with a high PGM loading in a front zone of the DOC. This means that the exotherm is generated at the front of the DOC but the strong heating effect is experienced by the rear portion of the DOC. By having a higher PGM concentration in the front which is cooler, the article has improved longevity and durability because this portion does not experience the highest temperatures.

According to a preferred configuration, the DOC has a front zone extending from the inlet end having a higher concentration of PGMs than a rear zone extending from the inlet end. Preferably the PGM concentration is at least 2 times greater in the front zone, more preferably at least 4 times and preferably from 4 to 10 times. The rear portion which typically has a lower PGM content is more resistant to sintering due to the lower PGM content. That is, when the rear zone has a lower loading of PGMs they are more spaced out and less likely to sinter together. Using lower amounts of PGMs in the rear zone is more efficient on the PGM use. Using higher amounts in the front zone allows for efficient exotherm generation but does not otherwise compromise performance. The front zone will perform passive CO and HC oxidation, while the rear zone is sufficient to then handle the competing NOx oxidation that also needs to occur.

Preferably the outlet zone (rear zone) has a lesser loading in g/in³ of Pt than the inlet zone (front zone). This is useful for efficient exotherm generating embodiments. In another embodiment, the outlet zone has a greater loading in g/in³ of Pt than the inlet zone.

According to a preferred embodiment, there is provided a method for the manufacture of a diesel oxidation catalyst, the method comprising:
(i) providing a carrier substrate;
(ii) forming one or more platinum-group-metal-containing washcoat layers on the carrier substrate to provide a first coated substrate, wherein the one or more platinum-group-metal-containing washcoat layers are on 100% of an axial length of the carrier, and comprise Pt and, optionally, Pd;
(iii) subjecting the first coated substrate to a first heat treatment to form a heat-treated coated substrate, wherein the first heat treatment comprises heating the first coated substrate to a first maximum temperature and holding the first coated substrate at the first maximum temperature;
(iv) depositing a platinum-group-metal-containing composition on at least a portion of the heat-treated coated substrate to form a second coated substrate, the composition forming an inlet zone on from 10 to 40% of an axial length of the carrier substrate; and
(v) subjecting the second coated substrate to a second heat treatment to form the diesel oxidation catalyst, wherein the second heat treatment comprises heating the second coated substrate to a second maximum temperature and holding the second coated substrate at the second maximum temperature;
wherein the first maximum temperature is a temperature of 600° C. to 750° C. and the first heat treatment is conducted under a moisture-containing atmosphere containing 5 to 15 wt % H₂O for from 1 to 3 hours, and wherein the second maximum temperature is from 450 to 550° C. in air.

According to a preferred embodiment, there is provided a method for the manufacture of a diesel oxidation catalyst, the method comprising:
(i) providing a carrier substrate;
(ii) forming one or more platinum-group-metal-containing washcoat layers on the carrier substrate to provide a first coated substrate, wherein the one or more platinum-group-metal-containing washcoat layers are on 100% of an axial length of the carrier, and comprise Pt and, optionally, Pd;
(iii) subjecting the first coated substrate to a first heat treatment to form a heat-treated coated substrate, wherein the first heat treatment comprises heating the first coated substrate to a first maximum temperature and holding the first coated substrate at the first maximum temperature;
(iv) depositing a platinum-group-metal-containing composition on at least a portion of the heat-treated coated substrate to form a second coated substrate, the composition forming an inlet zone on from 10 to 40% of an axial length of the carrier substrate; and
(v) subjecting the second coated substrate to a second heat treatment to form the diesel oxidation catalyst, wherein the second heat treatment comprises heating the second coated substrate to a second maximum temperature and holding the second coated substrate at the second maximum temperature;
wherein the first maximum temperature is a temperature of 650° C. to 725° C. and the first heat treatment is conducted under a moisture-containing atmosphere containing 5 to 15 wt % H₂O for from 1 to 3 hours, and wherein the second maximum temperature is from 475 to 525° C. in air for from 1 to 3 hours.

As will be appreciated, the above method defines the intervening aging treatment (the first heat treatment) and a final calcination step (second heat treatment) in order to describe the production of a DOC having an aged platinum-group-metal-containing washcoat layer thereon, and a fresh platinum-group-metal-containing composition deposited on an inlet end thereof. An alternative way to consider this is to consider the PGM material dispersion in each layer. When PGMs are applied in a washcoat they are general finely dispersed, whereas aging leads to a sintering effect of forming larger clumps of the PGMs. This means that the extent of aging can be determined by an inspection of the PGM dispersion. The product of the method described herein provides a unique structure with aged larger clumps in the underlying washcoat layer, but fresh finely dispersed PGMs in the upper layer (or impregnated within the underlying washcoat layer, giving a multimodal distribution).

Whether a PGM-containing layer has been aged can be determined using known techniques. Inductively Coupled Plasma Optical Emission Spectroscopy (ICP-OES) can be used to assess the form and condition of the PGM component in the catalyst. In this way it is possible to ascertain the extent of aging and to thereby demonstrate how portions of the catalyst are aged and portions are still fresh. In order to take a measurement, the CO uptake of a sample is measured using a Micromeritics Autochem 2920 instrument. The sample is pre-treated with hydrogen gas at 300° C. Carbon monoxide uptake is measured by pulse chemisorption at 50° C. The PGM material dispersion and particle size can then be calculated using the Autochem 2920 software based on the CO uptake and PGM material content for the sample. The dispersion of the PGM material is a measurement of the particle size of the PGM material. Large particles with a low surface area have a low dispersion. Thus, the technique allows a determination of the extent to which the PGMs applied have sintered together by aging.

Preferably the aged platinum-group-metal-containing washcoat layer comprises platinum-group-metal particulates having a mean particulate size (D50) greater than 10 nm, as determined by TEM, and the fresh platinum-group-metal-containing composition comprises platinum-group-metal particulates, said particulates having a D90 particulate size less than nm, as determined by TEM. It is possible to assess these characteristics by TEM inspection of each layer or zone applied.

According to a further aspect, there is provided a diesel oxidation catalyst article comprising a flow-through carrier substrate having an aged platinum-group-metal-containing washcoat layer thereon, and a fresh platinum-group-metal-containing composition deposited on an inlet end thereof, wherein the aged platinum-group-metal-containing washcoat layer comprises platinum-group-metal particulates having a mean particulate size (D50) greater than 10 nm, as determined by TEM, and the fresh platinum-group-metal-containing composition comprises platinum-group-metal particulates, said particulates having a D90 particulate size less than 10 nm, as determined by TEM. Advantageously, this configuration provides stabilised NO oxidation without significant impact on CO/HC and exotherm activity.

Preferably the diesel oxidation catalyst is obtained or is obtainable by the method described herein.

According to a further aspect, there is provided an exhaust gas treatment system comprising the diesel oxidation catalyst described herein arranged upstream of one of:
(A) a soot filter;
(B) an SCR catalyst article;
(C) an SCRF catalyst article;
(D) a catalysed soot filter;
(E) a soot filter and then an SCR catalyst article; or
(F) a catalysed soot filer and then an SCR catalyst article.

These components are all well known in the art. These components can benefit from the provision of the DOC obtained by the method disclosed herein in an upstream position in one of two ways. Some of these components, such as the soot filter, benefit from the exotherm provision ability of the DOC. This additional heat serves to enhance soot combustion and removal. Others of these components benefit specifically from the stabilised NO₂ production ability.

This is particularly the case for the SCR and SCRF components. The selective catalytic reduction (SCR) of NOx primarily occurs by the following three reactions:

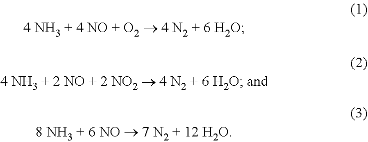

The ratio of NO₂: NO in the exhaust gas that enters an SCR catalyst or SCRF catalyst can therefore affect its performance (see reaction 2). In general, SCR catalysts or SCRF catalysts show optimum performance when the ratio of NO₂: NO is about 1:1. This can be problematic because the exhaust gas produced by a compression ignition engine during normal use typically contains insufficient NO₂ (i.e. the ratio of NO₂: NO is much lower than 1:1) for optimal performance of the SCR catalyst or the SCRF catalyst.

To compensate for such low levels of NO₂, the DOC is formulated to oxidise nitrogen monoxide (NO) to nitrogen dioxide (NO₂), thereby increasing the ratio of NO₂: NO in the exhaust gas. By providing an improved DOC where the NO₂ production levels are maintained throughout the operating lifetime, it is possible to optimise the levels of PGMs in the part.

According to a further aspect, there is provided a diesel combustion and exhaust gas treatment system, comprising a diesel combustion engine and the exhaust system described herein.

According to a further aspect, there is provided a method for the manufacture of the exhaust system described herein, the method comprising, forming a diesel oxidation catalyst according to the method described herein and arranging this upstream of any of (A) to (F).

### DEFINITIONS

As used herein, the singular form of “a”, “an” and “the” include plural references unless the context clearly dictates otherwise.

The use of the term “comprising” is intended to be interpreted as including such features but not excluding other features and is also intended to include the option of the features necessarily being limited to those described. In other words, the term also includes the limitations of “consisting essentially of” (intended to mean that specific further components can be present provided they do not materially affect the essential characteristic of the described feature) and “consisting of” (intended to mean that no other feature may be included such that if the components were expressed as percentages by their proportions, these would add up to 100%, whilst accounting for any unavoidable impurities), unless the context clearly dictates otherwise.

As used herein, the term “on” is intended to mean “directly on” such that there are no intervening layers between one material being said to be “on” another material. Spatially relative terms, such as “below”, “beneath”, “lower”, “above”, “upper” and the like, may be used herein for ease of description to describe one element or feature's relationship to another element(s) or feature(s). It will be understood that the spatially relative terms are intended to encompass different orientations of the catalyst in use or operation in addition to the orientation depicted in the figures.

The term “calcine”, or “calcination”, means heating the material in air or oxygen. This definition is consistent with the IUPAC definition of calcination. (IUPAC. Compendium of Chemical Terminology, 2nd ed. (the “Gold Book”). Compiled by A. D. McNaught and A. Wilkinson. Blackwell Scientific Publications, Oxford (1997). XML on-line corrected version: http://goldbook.iupac.org (2006-) created by M. Nic, J. Jirat, B. Kosata; updates compiled by A. Jenkins. ISBN 0-9678550-9-8. doi: 10.1351/goldbook). The temperatures used in calcination depend upon the components in the material to be calcined. According to Chapters 2.3.3 and 2.3.4 in R. M. Heck et al, “Catalytic Air Pollution Control-Commercial Technology”, John Wiley & Sons, Inc., 3^{rd} Edition (2009), washcoat-applied catalytic species on monolithic substrates for automotive application, including platinum and palladium salts, are forced air dried at about 110° C. and calcined in forced air to about 400-500° C. to remove all traces of decomposable salts used to prepare the catalyst. In applications involving the processes described herein (i.e. conventional DOC preparation and the second heat treatment), calcinations are generally performed at temperatures from about 400° C. to about 600° C. for approximately 1 to 8 hours, preferably at temperatures from about 400° C. to about 550° C. for approximately 1 to 4 hours.

### FIGURES

The present invention will now be described further with reference to the following non limiting Figures, in which:

FIG. 1 shows a schematic of the layers formed in the method described herein.

FIG. 2 shows a flow-chart of the key steps of the method described herein.

FIG. 3 shows a NO₂/NOx performance at different temperatures for a conventional DOC and one made in accordance with the invention.

FIG. 4 shows PGM particle size for a conventional DOC and FIG. 5 shows PGM size for one made in accordance with the invention.

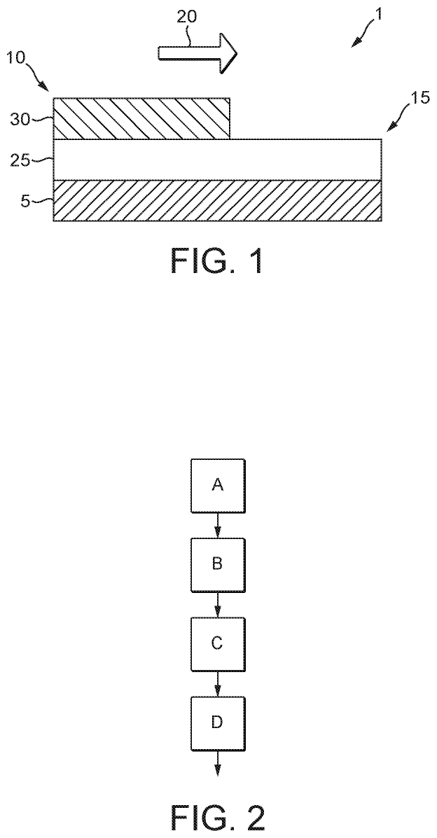

As shown in FIG. 1, there is provided a DOC 1. The DOC 1 comprises a substrate 5. The substrate 5 is preferably a flow-through substrate, such as a porous cordierite form. The substrate 5 has an inlet end 10, for receiving an exhaust gas to be treated, and an outlet end 15, for releasing the treated exhaust gas. The exhaust gas flow direction is shown by the arrow 20.

The substrate 5 has a PGM-containing layer 25 provided along the entire length of the substrate 5 by washcoating. This is generally a Pt-only, or Pd and Pt-containing, layer. The total PGM content of this layer is typically from 10 to 50 g/ft³. The PGM content is provided on a support material, such as alumina. The PGM-containing layer 25 has been subjected to an aging process, which stabilises the NO oxidation performance of this layer.

On top of the PGM-containing layer 25 there is provided at the inlet end 10 an additional PGM-containing zone 30. This can be applied by washcoating or impregnation or the like. This zone 30 preferably comprises Pt and typically provides a further 10 to 50 g/ft³ of PGMs. This zone 30 has not been subjected to an aging process, so it has fresh activity. This provides enhanced exotherm generation at the inlet of the DOC.

As shown in FIG. 2, the method comprises:
(A) providing a carrier substrate 5;
(B) forming a PGM-containing layers 25 on the carrier substrate 5;
(C) aging the PGM-containing layers 25 on the carrier substrate 5 at a temperature of 650° C. under a 10 wt % moisture-containing atmosphere for a time period of 1 to 3 hours;
(D) forming a PGM-containing zone 30 on the aged PGM-containing layers 25 on the carrier substrate 5.

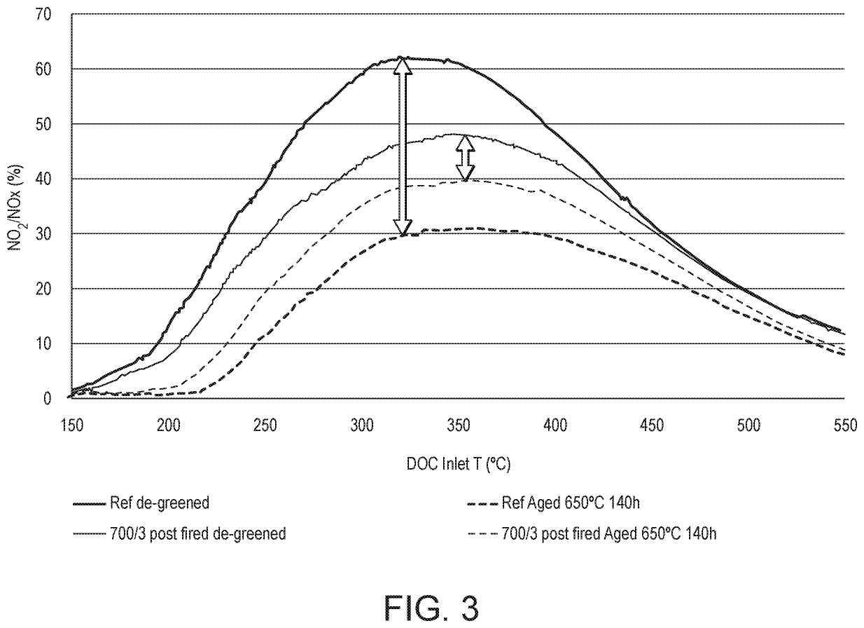

As shown in FIG. 3, a conventional reference DOC exhibits a large drop in NO₂/NOx performance between fresh (i.e. de-greened) performance and aged performance (650C for 140 hrs). In contrast, while the DOC made in accordance with the invention exhibits a much smaller delta between fresh (i.e. de-greened) performance and aged performance (650C for 140 hrs). The DOC made in accordance with the invention had a first heat treatment at 700C for 3 hours.

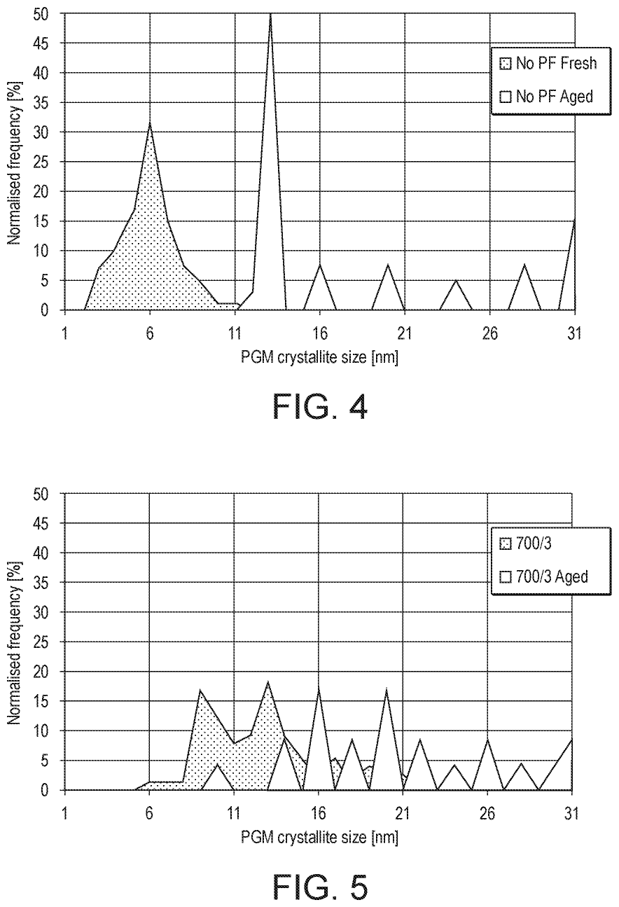

FIG. 4 shows the significant change in PGM particulate size in the reference part, between a starting size of around 6 nm (D90 less than 10 nm), and broadly distributed after aging (D50 above 10 nm). In contrast, FIG. 5 shows how the PGM particulate size of the DOC obtained in accordance with the invention has a starting size with a D50 above 10 nm. After aging the particle size is generally lower than that in the comparative data. That is, the change in PGM particulate size in the DOC of the invention is lower.

It should be noted that FIGS. 4 and 5 only consider the PGM particle size in the one or more platinum-group-metal-containing washcoat layers on the carrier substrate. Therefore, the DOC obtained in accordance with the invention will have an additional distribution of PGMs (such as in an upper washcoat layer) with a D90 of less than 15 nm, preferably less than nm.

### EXAMPLES

The present invention will now be described further in relation to the following non-limiting examples.

The invention will now be illustrated by the following non-limiting examples. For the avoidance of doubt all coating steps were done using the methods and apparatus disclosed in Applicant's WO 99/47260, i.e. comprising the steps of (a) locating a containment means on top of a substrate, (b) dosing a pre-determined quantity of a liquid component into said containment means, either in the order (a) then (b) or (b) then (a), and (c) by applying vacuum, drawing the entirety of said quantity of liquid component into at least a portion of the substrate, and retaining substantially all of said quantity within the substrate, without recycle.

### Example 1 (Reference)

A bare cordierite honeycomb flow-through substrate monolith of 13 inches in length×5 inches in diameter was coated with catalyst washcoat in a zoned arrangement as follows. A first catalyst washcoat slurry containing aqueous salts (as nitrates) of platinum and palladium and a particulate gamma-alumina support material was coated onto the substrate monolith to an axial length of 80% of the total substrate monolith length from one end labelled as the inlet end. The concentrations of platinum and palladium salts were selected to achieve a loading in the coating of 6.65 Pt: 6.65Pd gft⁻³, i.e. a total PGM loading of 13.3 gft⁻³ at a weight ratio of platinum to palladium in the first catalyst washcoat coating of 1:1. This inlet coating was then dried in a conventional oven for 1 hour at 100° C. to remove excess water and other volatile species.

A second catalyst washcoat slurry containing an aqueous platinum nitrate salt as the only platinum group metal present and a particulate gamma-alumina support material was coated onto the substrate already coated with the first coating from the end of the substrate monolith opposite to the end from which the first coating was applied, i.e. the outlet end. The axial length of coating of the second catalyst washcoat was 75% of the total substrate length, i.e. 50% of the second washcoat catalyst coating overlapped with the first washcoat catalyst coating. The concentration of platinum salt used was selected to achieve a 2.02 gft⁻³ Pt loading in the 75% axial substrate length coated. The substrate coated with both the first and the second washcoat coatings was dried in a conventional oven for 1 hour at 100° C. and then the dried part was calcined for 1 hour at 500° C. to decompose the platinum and palladium salts and fix the platinum and palladium to the particulate gamma-alumina support material.

An aqueous medium comprising salts of both platinum nitrate and palladium nitrate at a 1:1 weight ratio was then impregnated onto the coating of the first catalyst washcoat to an axial length of the substrate of 25% measured from the substrate inlet end. The concentrations of the salts were selected to achieve a weight of 35 gft⁻³ for each of the platinum and palladium in the impregnated length of the substrate. This gave a high PGM loading in a zone at the inlet end with an additional loading of 35 g ft⁻³ over and above that of the underlying first catalyst washcoat coating. The impregnated part was dried in a conventional oven for 1 hour at 100° C. and then the dried part was calcined for 1 hour at 500° C. All washcoats and impregnation solutions were naturally acidic and there was no pH adjustment thereof.

The final product comprised a substrate monolith comprising three catalyst washcoat zones arranged axially in series: a first, high loaded front zone defined as about 25% of the axial length of the substrate monolith measured from the inlet end and having a total platinum group metal loading which was a combination of the underlying 1 Pt:1Pd first catalyst washcoat and the impregnated 1:1 Pt:Pd, followed axially in series by a second catalyst washcoat zone comprised of the superimposition of the Pt only second catalyst washcoat on the 1Pt:1Pd first catalyst washcoat of approximately 50% of the axial length of the substrate monolith at a lower total platinum group metal loading than the first catalyst washcoat zone;

and finally a third Pt-only zone at the outlet end comprised of the second catalyst washcoat coating of approximately 25% of the axial length of the substrate monolith at a lower total platinum group metal loading than either the first or the second catalyst washcoat zones. The total platinum group metal loading on the substrate monolith as a whole was 21 gft⁻³ at a total Pt: Pd weight ratio of 7:6, equivalent to 1.167:1. The resulting catalyst is described herein as “fresh”, i.e. as made.

### Example 2 (Comparative)

An identical product to that disclosed in Reference Example 1 was prepared, except that the impregnated part was dried in a conventional oven for 1 hour at 100° C. and then the dried part was calcined for 3 hours at 700° C. The resulting catalyst is described herein as “fresh”, i.e. as made.

### Example 3

A product similar to that of Comparative Example 2 was prepared except that the order of the calcination and impregnation steps was reversed. That is, after calcining the substrate coated with the first and second overlapping coatings for 1 hour at 500° C., the product was further aged by calcining in air to 700° C. for 3 hours. The first catalyst washcoat of this product was then impregnated with the aqueous medium comprising salts of both platinum nitrate and palladium nitrate at a 1:1 weight ratio to an axial length of the substrate of 25% measured from the substrate inlet end. The impregnated part was oven dried for 1 hour at 100° C. and then the dried part was calcined for 1 hour at 500° C. The resulting catalyst is described herein as “fresh”, i.e. as made.

### Example 4—Test Method

A thermal analysis of each aged composite oxidation catalyst prepared according to Reference Example 1, Comparative Example 2 and Example 3 (according to the invention) was performed using a laboratory bench-mounted diesel engine. The engine was fueled with EUVI B7 fuel (7% Biofuel) for both engine operation and exhaust gas hydrocarbon enrichment (exotherm generation), running at 2200 rpm and was fitted with an exhaust system including exhaust piping and demountable canning into which each of the composite oxidation catalysts could be inserted for testing with the inlet end/first catalyst, high-loaded washcoat zone oriented to the upstream side. The engine was a 7-litre capacity EUV 6-cylinder engine, producing 235 KW at 2500 rpm and the exhaust system included a “7^{th} injector” disposed to inject hydrocarbon fuel directly into the exhaust gas piping downstream from the engine manifold and upstream from the composite oxidation catalyst to be tested. This injector is named the “7^{th} injector” because it is additional to the six fuel injectors associated with the cylinders of the engine. Thermocouples were located at the inlet to the composite oxidation catalyst and were inserted at various axial locations along the centre line of the substrate monolith of each composite oxidation catalyst.

De-greened fresh (see hereinbelow) and aged NO oxidation activity of each catalyst was performed as follows. Ageing was done as follows. Each composite oxidation catalyst prepared according to Reference Example 1, Comparative Example 2 and Example 3 (according to the invention) was tested for average NO oven-aged in air at 650° C. for 140 hours corresponding to end-of-vehicle-life activity. A speed/load map for detected NO₂/total NOₓ was prepared and an integrated average in a quadrant 400 to 1000 kg/hour mass flow vs. 200-350° C. catalyst inlet temperature was calculated and is reported in Table 1 hereinbelow.

An exotherm test was performed as follows. Each aged catalyst was conditioned for 10 minutes at an inlet exhaust gas temperature of 490° C. at an exhaust gas flow-rate of 1000 kg/hour followed by a rapid cooling step, a process known as “de-greening”). The exhaust gas flow rate was then set to 720 kg/hour (corresponding to 120,000 hr⁻¹ space velocity for the size and volume of substrate tested) with the engine load controlled so that a stable set inlet exhaust gas temperature of about 270° C. was achieved for approximately 1800 seconds.

The ability for the composite oxidation catalyst to generate an exotherm at each stabilised set temperature was then tested by injecting hydrocarbon fuel via the 7th injector targeting both 600° C. and a stable hydrocarbon “slip” at the outlet of the composite oxidation catalyst substrate via downstream thermocouple and hydrocarbon sensors. The test was stopped if the hydrocarbon slip measured downstream from the composite oxidation catalyst exceeded 1000 ppm C₃, i.e. no matter what the length of the hydrocarbon chain in the detected hydrocarbons—the modal carbon chain length in a typical diesel fuel is C₁₆—the test would be stopped if the equivalent of 1000 ppm C₃ was detected. So, if 187.5 ppm C₁₆ were detected, this was equivalent to 1000 ppm C₃ (C₁₆ is equivalent to 5⅓×C₃ hydrocarbons). Following the test at the about 270° C. set inlet temperature, the system was again preconditioned at an inlet exhaust gas temperature of 490° C. for 10 minutes at a flow rate of 1000 kg/hour followed by a rapid cooling and an exotherm test at a second set temperature, e.g., about 260° C. This cycle was repeated to test exotherm generation at set temperatures of about 250° C., 240° C. and 230° C. The test was stopped when either the composite oxidation catalyst cannot generate a stable exotherm of 600° C. at the composite oxidation catalyst outlet end or the hydrocarbon slip measured at the composite oxidation catalyst outlet exceeds 1000 ppm (C₃).

TABLE 1

| | Average % NO₂/NOx | | |
|---|---|---|---|
| | | Aged | Exotherm |
| | “Fresh” (de- | (end of | Aged (end |
| | greened) | life) | of life) |
| Reference | 54.6% | 43.7% | 252° C. |
| Example 1 | | | |
| Comparative | 37.8% | 33.1% | 269° C. |
| Example 2 | | | |
| Example 3 | 41.0% | 35.2% | 254° C. |
| (according to | | | |
| the invention) | | | |

The results for these tests performed on Reference Example 1, Comparative Example 2 and Example 3 (according to the invention) are set out in Table 1 above. It will be understood that the lower the inlet temperature at which a stable exotherm can be achieved at acceptable hydrocarbon slip, the more advantageous. This is because the design flexibility in the system is increased in that a filter regeneration event can be initiated from a lower inlet exhaust gas temperature, i.e. without needing to wait until the exhaust gas temperature under normal operating conditions is sufficiently high to initiate filter regeneration, which may occur less frequently in ordinary operation Also, it improves overall fuel economy because it is not necessary to inject as much hydrocarbon in order to achieve a desired exhaust gas temperature at the outlet to the composite oxidation catalyst.

Additionally, it can be seen from the oxidation activity for each catalyst that the difference in NO oxidation activity from fresh to aged is lower for Comparative Example 2 (37.8% minus 33.1%=4.7%) and Example 3 (according to the invention) (41.0% minus 35.2%=5.8%) than for Reference Example 1 (54.6% minus 43.7%=10.9%). The lower the “delta” between fresh and aged catalyst activity, the easier it is for OEM customers to program engine control units with algorithms which allow for degradation of NO oxidation catalyst activity over time and accordingly adjust urea injection on a downstream SCR catalyst; or program shortening intervals in downstream active filter regeneration that uses passive soot combustion in NO₂ using the CRT® effect between active regeneration events.

Therefore, the catalyst of Example 3 according to the invention combines a lower average NO₂/NOₓ ratio delta between fresh and aged than Reference Example 1; and the ability to generate an exotherm at a lower temperature than Comparative Example 2.

The foregoing detailed description has been provided by way of explanation and illustration and is not intended to limit the scope of the appended claims. Many variations of the presently preferred embodiments illustrated herein will be apparent to one of ordinary skill in the art and remain within the scope of the appended claims and their equivalents.

For the avoidance of doubt, the entire content of any and all documents cited herein is incorporated by reference into the present application.

1. A method for the manufacture of a diesel oxidation catalyst, the method comprising:
(i) providing a carrier substrate;
(ii) forming one or more platinum-group-metal-containing washcoat layers each comprising a refractory metal oxide support material on the carrier substrate to provide a first coated substrate;
(iii) subjecting the first coated substrate to a first heat treatment to form a heat-treated coated substrate, wherein the first heat treatment comprises heating the first coated substrate to a first maximum temperature and holding the first coated substrate at the first maximum temperature;
(iv) depositing a platinum-group-metal-containing composition comprising a refractory metal oxide support material on at least a portion of the heat-treated coated substrate to form a second coated substrate; and
(v) subjecting the second coated substrate to a second heat treatment to form the diesel oxidation catalyst, wherein the second heat treatment comprises heating the second coated substrate to a second maximum temperature and holding the second coated substrate at the second maximum temperature; wherein the first maximum temperature is at least 600° C. and wherein the second maximum temperature is at least 25° C. lower than the first maximum temperature.

2. The method according to claim 1, wherein the first heat treatment is conducted under a moisture-containing atmosphere.

3. The method according to claim 1, wherein the first heat treatment is performed:
(a) with the first maximum temperature of from 625 to 750° C., preferably from 650 to 700° C.; and/or
(b) with the first coated substrate held at the first maximum temperature for at least 30 minutes, preferably for from 1 hour to 3 hours; and/or
(c) under conditions of 5 to 15 wt % H₂O.

4. The method according to claim 1, wherein the second heat treatment is performed:
(a) with the second maximum temperature of from 400 to 575° C., preferably from 450 to 550° C.; and/or
(b) with the second coated substrate held at the second maximum temperature for at least 30 minutes, preferably for from 1 hour to 3 hours.

5. The method according to claim 1, wherein the carrier substrate is a flow-through substrate.

6. The method according claim 1, wherein the one or more platinum-group-metal-containing washcoat layers on the carrier substrate comprise Pt and/or Pd.

7. The method according to claim 1, wherein the one or more platinum-group-metal-containing washcoat layers on the carrier substrate further comprises an alkaline earth metal, preferably strontium and/or barium.

8. The method according to claim 1, wherein the coated substrate has a continuous platinum-group-metal-containing coating extending from an inlet end to the outlet end of the carrier substrate.

9. The method according to claim 8, wherein the continuous platinum-group-metal-containing coating is zoned, wherein an inlet zone comprises Pt and Pd, and whereby an outlet zone comprises Pt and, optionally Pd, and wherein:
(i) the outlet zone has a lesser loading in g/in³ of Pt than the inlet zone, or
(ii) the outlet zone has a greater loading in g/in³ of Pt than the inlet zone.

10. The method according to claim 9, wherein the continuous platinum-group-metal-containing coating consists of the inlet and outlet zones.

11. The method according to claim 1, wherein step (iv) comprises:
(I) applying a platinum-group-metal-containing washcoat to the first coated substrate, preferably forming a washcoat zone extending from an inlet end of the substrate; or
(II) impregnating the first coated substrate with a solution of a platinum-group-metal-containing salt, preferably forming a platinum-group-metal-impregnated zone extending from an inlet end of the substrate.

12. The method according to claim 1, wherein the heat-treated coated substrate comprises platinum-group-metal particulates having a mean particulate size (D50) greater than 10 nm, preferably greater than 20 nm, as determined by TEM.

13. The method according to claim 1, wherein the diesel oxidation catalyst comprises a layer or zone formed in step (iv) which comprises platinum-group-metal particulates, said particulates having a D90 particulate size less than 15 nm, preferably less than 10 nm as determined by TEM.

14. A diesel oxidation catalyst article comprising a flow-through carrier substrate having an aged platinum-group-metal-containing washcoat layer thereon, and a fresh platinum-group-metal-containing composition deposited on an inlet end thereof, wherein the aged platinum-group-metal-containing washcoat layer comprises platinum-group-metal particulates having a mean particulate size (D50) greater than 10 nm, as determined by TEM, and wherein the fresh platinum-group-metal-containing composition comprises platinum-group-metal particulates, said particulates having a D90 particulate size less than 10 nm, as determined by TEM.

15. A diesel oxidation catalyst article comprising a flow-through carrier substrate having an aged platinum-group-metal-containing washcoat layer thereon, and a fresh platinum-group-metal-containing composition deposited on an inlet end thereof, wherein the aged platinum-group-metal-containing washcoat layer comprises platinum-group-metal particulates having a mean particulate size (D50) greater than 10 nm, as determined by TEM, and wherein the fresh platinum-group-metal-containing composition comprises platinum-group-metal particulates, said particulates having a D90 particulate size less than 10 nm, as determined by TEM, obtained by or obtainable by the method according to claim 1.

16. An exhaust gas treatment system comprising the diesel oxidation catalyst according to claim 14 arranged upstream of:
(A) a soot filter;
(B) an SCR catalyst article;
(C) an SCRF catalyst article;
(D) a catalysed soot filter;
(E) a soot filter and then an SCR catalyst article; or
(F) a catalysed soot filer and then an SCR catalyst article.

17. A diesel combustion and exhaust gas treatment system comprising a diesel combustion engine and the exhaust system according to claim 16.

18. A method for the manufacture of an exhaust gas treatment system comprising a diesel oxidation catalyst article comprising a flow-through carrier substrate having an aged platinum-group-metal-containing washcoat layer thereon, and a fresh platinum-group-metal-containing composition deposited on an inlet end thereof, wherein the aged platinum-group-metal-containing washcoat layer comprises platinum-group-metal particulates having a mean particulate size (D50) greater than 10 nm, as determined by TEM, and wherein the fresh platinum-group-metal-containing composition comprises platinum-group-metal particulates, said particulates having a D90 particulate size less than 10 nm, as determined by TEM, arranged upstream of:
(A) a soot filter;
(B) an SCR catalyst article;
(C) an SCRF catalyst article;
(D) a catalysed soot filter;
(E) a soot filter and then an SCR catalyst article; or
(F) a catalysed soot filer and then an SCR catalyst article, and
the method comprising, forming a diesel oxidation catalyst according to the method of claim 1 and arranging this upstream of any of (A) to (F).
